(19) United States
(12) Patent Application Publication
(10) Pub. No.: US 2024/0296773 A1
(43) Pub. Date: Sep. 5, 2024

(54) DISPLAY PANEL COMPENSATION METHOD AND DEVICE, AND STORAGE MEDIUM

(71) Applicant: Xiamen Tianma Display Technology Co., Ltd., Xiamen (CN)

(72) Inventors: Wang YU, Xiamen (CN); Yang LIU, Xiamen (CN); Jingxiong ZHOU, Xiamen (CN)

(73) Assignee: Xiamen Tianma Display Technology Co., Ltd., Xiamen (CN)

(21) Appl. No.: 18/662,469

(22) Filed: May 13, 2024

(30) Foreign Application Priority Data
Dec. 25, 2023 (CN) 202311803102.2

(51) Int. Cl. G09G 3/20

(52) U.S. Cl. CPC G09G 3/2007; G09G 2320/0209; G09G 2320/0266

(57) ABSTRACT

A display panel compensation method includes: obtaining an initial data voltage value of each pixel in a display panel according to a to-be-displayed image; determining a to-be-compensated region of the display panel according to the initial data voltage value of each pixel in the display panel, where the to-be-compensated region includes a first to-be-compensated region and a second to-be-compensated region that are adjacent to each other in a first direction; and determining a first compensation voltage value of a first pixel in the first to-be-compensated region according to the difference between an initial data voltage value of the first pixel in the first to-be-compensated region and a first target voltage value, and determining a second compensation voltage value of a second pixel in the second to-be-compensated region according to the difference between an initial data voltage value of the second pixel in the second to-be-compensated region and a second target voltage value.

### CROSS-REFERENCE TO RELATED APPLICATION(S)

This application claims priority to Chinese Patent Application No. 202311803102.2 filed Dec. 25, 2023, the disclosure of which is incorporated herein by reference in its entirety.

### TECHNICAL FIELD

The present application relates to the field of display technology and, in particular, to a display panel compensation method and apparatus, a device, and a storage medium.

### BACKGROUND

As display technology updates continuously, users have increasingly high requirements on the use performance of display panels.

A display panel is applicable to different display scenarios during use. However, in some display scenarios, a bright line or a dark line easily appears in a display image.

### SUMMARY

Embodiments of the present application provide a display panel compensation method and apparatus, a device, and a storage medium, which can determine a compensation voltage value according to an actual to-be-displayed image. Thus, dynamic compensation can be implemented and the problem is alleviated that a bright line or a dark line easily appears in a display image.

In a first aspect, an embodiment of the present application provides a display panel compensation method. The method includes: obtaining an initial data voltage value of each pixel in a display panel according to a to-be-displayed image; determining a to-be-compensated region of the display panel according to the initial data voltage value of each pixel in the display panel, where the to-be-compensated region includes a first to-be-compensated region and a second to-be-compensated region that are adjacent to each other in a first direction, and the absolute value of the difference between an initial data voltage value of a first pixel in the first to-be-compensated region and an initial data voltage value of a second pixel in the second to-be-compensated region is larger than a first threshold; and determining a first compensation voltage value of the first pixel in the first to-be-compensated region according to the difference between the initial data voltage value of the first pixel in the first to-be-compensated region and a first target voltage value, and determining a second compensation voltage value of the second pixel in the second to-be-compensated region according to the difference between the initial data voltage value of the second pixel in the second to-be-compensated region and a second target voltage value.

Based on the same inventive concept, in a second aspect, an embodiment of the present application provides a display panel compensation apparatus. The apparatus includes a data acquisition module, a compensation position determination module, and a compensation data determination module.

The data acquisition module is configured to obtain an initial data voltage value of each pixel in a display panel according to a to-be-displayed image.

The compensation position determination module is configured to determine a to-be-compensated region of the display panel according to the initial data voltage value of each pixel in the display panel, where the to-be-compensated region includes a first to-be-compensated region and a second to-be-compensated region that are adjacent to each other in a first direction, and the absolute value of the difference between an initial data voltage value of a first pixel in the first to-be-compensated region and an initial data voltage value of a second pixel in the second to-be-compensated region is larger than a first threshold.

The compensation data determination module is configured to determine a first compensation voltage value of the first pixel in the first to-be-compensated region according to the difference between the initial data voltage value of the first pixel in the first to-be-compensated region and a first target voltage value and determine a second compensation voltage value of the second pixel in the second to-be-compensated region according to the difference between the initial data voltage value of the second pixel in the second to-be-compensated region and a second target voltage value.

Based on the same inventive concept, in a third aspect, an embodiment of the present application provides an electronic device. The electronic device includes a processor and a memory that stores a computer program instruction, where when executing the computer program instruction, the processor implements the display panel compensation method according to the embodiment in the first aspect.

Based on the same inventive concept, in a fourth aspect, an embodiment of the present application provides a computer-readable storage medium configured to store a computer program. When executing the computer program, a processor implements the display panel compensation method according to the embodiment in the first aspect.

According to the display panel compensation method and apparatus, the device, and the storage medium provided in the embodiments of the present application, the initial data voltage value of the pixel is obtained according to the actual to-be-displayed image, then the to-be-compensated region is determined based on the initial data voltage value of the pixel, and the compensation voltage value of the pixel in the to-be-compensated region is determined according to the difference between the initial data voltage value of the pixel in the to-be-compensated region and the target voltage value. At different refresh rates, the initial data voltage value may be different, and further, the obtained compensation voltage value may be different. In this way, compensation in different scenarios may no longer be performed based on one fixed compensation value, thereby implementing the dynamic compensation.

### BRIEF DESCRIPTION OF DRAWINGS

Other features, objects, and advantages of the present application will be clearer from the following detailed description of non-limiting embodiments with reference to drawings. The same or similar reference numerals denote identical or similar features. The drawings are not drawn to the actual scale.

FIG. 1 shows a schematic diagram of a display scenario of a display panel according to an embodiment of the present application;

FIG. 2 shows a flowchart of a display panel compensation method according to an embodiment of the present application;

FIG. 3 shows a schematic diagram of another display scenario of a display panel according to an embodiment of the present application;

FIG. 4 shows a structural diagram of some regions in FIG. 3;

FIG. 5 shows another flowchart of a display panel compensation method according to an embodiment of the present application;

FIG. 6 shows another flowchart of a display panel compensation method according to an embodiment of the present application;

FIG. 7 shows another flowchart of a display panel compensation method according to an embodiment of the present application;

FIG. 8 shows another flowchart of a display panel compensation method according to an embodiment of the present application;

FIG. 9 shows a structural diagram of a display panel compensation apparatus according to an embodiment of the present application; and

FIG. 10 shows a structural diagram of an electronic device according to an embodiment of the present application.

### DETAILED DESCRIPTION

Features and example embodiments in various aspects of the present application are described below in detail. To provide a clearer understanding of the objects, technical solutions, and advantages of the present application, the present application is further described below in detail in conjunction with drawings and embodiments. It is to be understood that the embodiments described here are only configured to illustrate and not to limit the present application. For those skilled in the art, the present application may be implemented without some of these specific details. The following description of the embodiments is only intended to provide a better understanding of the present application through examples of the present application.

It is to be noted that relationship terms such as first and second used herein, are used only for distinguishing one entity or operation from another and do not necessarily require or imply any such actual relationship or order between these entities or operations. Furthermore, the term “comprising”, “including” or any other variant thereof is intended to encompass a non-exclusive inclusion so that a process, method, article, or device that includes a series of elements not only includes the expressly listed elements but may also include other elements that are not expressly listed or are inherent to such process, method, article, or device. In the absence of more restrictions, the elements defined by the statement “including . . . ” do not exclude the presence of additional identical elements in the process, method, article, or device that includes the elements.

It is to be understood that the term “and/or” used herein only describes the association relationships between associated objects and indicates that three relationships may exist. For example, A and/or B may indicate the three cases: A exists alone, A and B both exist, and B exists alone. Additionally, the character “/” used herein typically indicates that the associated objects before and after the character are in an “or” relationship.

It is apparent to those skilled in the art that various modifications and variations can be made in the present application without departing from the spirit or scope of the present application. Therefore, the present application is intended to cover modifications and variations of the present application that fall within the scope of the corresponding claims (the claimed technical solutions) and equivalents thereof. It is to be noted that implementations provided in the embodiments of the present application may be combined with each other if there is no contradiction.

Before the technical solutions provided in the embodiments of the present application are set forth, to facilitate the understanding of the embodiments of the present application, the present application first specifically describes the problems existing in the related art.

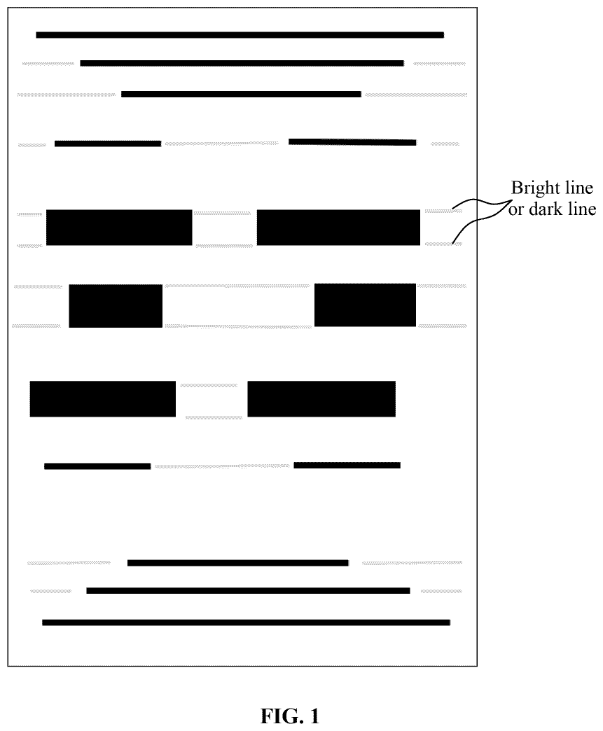

As shown in FIG. 1, in the case where a display of a display panel has a clear transition between a black image and a white image, a bright line or a dark line easily appears at a position corresponding to the junction between the black image and the white image. For example, an application search box at the end of a whole machine is switched to an application at a screen end, and the switch between a black block and a white block exists in an entire display image. In this display scenario, the bright line or the dark line easily appears at a black-and-white junction.

The inventor has studied the reasons for the preceding technical problems. The main reason is that when a power signal on a power line (a PVDD wire) of the display panel varies with a load, a coupling effect is produced between a signal on the power line and a signal on a data line (a source wire). Therefore, the bright line or the dark line is easily presented at the black-and-white junction. This phenomenon may be referred to as a line crosstalk.

In the related art, compensation can only be performed based on the same fixed value. When the refresh rate is switched, compensation capability may result in over-compensation or under-compensation, and corresponding satisfactory compensation cannot be provided.

For the preceding technical problem, the embodiments of the present application provide a display panel compensation method and apparatus, a device, and a storage medium. The embodiments of the present application are described below in conjunction with the drawings.

The display panel compensation method provided in an embodiment of the present application is first described below.

The display panel compensation method provided in the embodiment of the present application is applicable to an organic light-emitting diode (OLED) display panel.

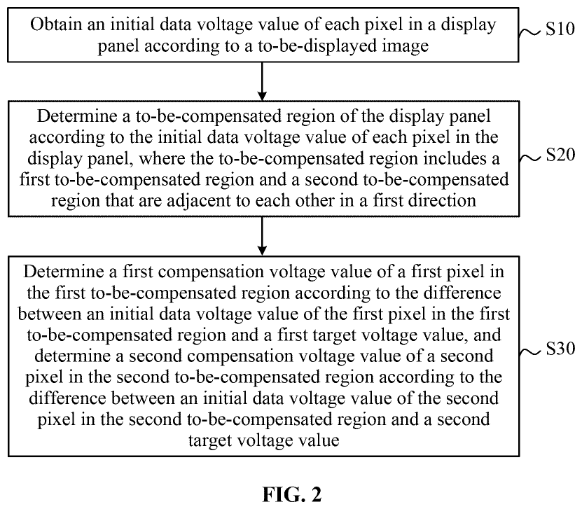

As shown in FIG. 2, the display panel compensation method provided in the embodiment of the present application may include S10 to S30.

In S10, an initial data voltage value of each pixel in a display panel is obtained according to a to-be-displayed image.

In S20, a to-be-compensated region of the display panel is determined according to the initial data voltage value of each pixel in the display panel, where the to-be-compensated region includes a first to-be-compensated region and a second to-be-compensated region that are adjacent to each other in a first direction, and the absolute value of the difference between an initial data voltage value of a first pixel in the first to-be-compensated region and an initial data voltage value of a second pixel in the second to-be-compensated region is larger than a first threshold.

In S30, a first compensation voltage value of the first pixel in the first to-be-compensated region is determined according to the difference between the initial data voltage value of the first pixel in the first to-be-compensated region and a first target voltage value, and a second compensation voltage value of the second pixel in the second to-be-compensated region is determined according to the difference between the initial data voltage value of the second pixel in the second to-be-compensated region and a second target voltage value.

Specific implementations of the preceding steps are described below in detail.

According to the display panel compensation method provided in the embodiment of the present application, the initial data voltage value of the pixel is obtained according to the actual to-be-displayed image, then the to-be-compensated region is determined based on the initial data voltage value of the pixel, and the compensation voltage value of the pixel in the to-be-compensated region is determined according to the difference between the initial data voltage value of the pixel in the to-be-compensated region and the target voltage value. At different refresh rates, the initial data voltage value may be different, and further, the obtained compensation voltage value may be different. In this way, compensation in different scenarios may no longer be performed based on one fixed compensation value, thereby implementing dynamic compensation and alleviating the problem that the bright line or the dark line easily appears in the display image.

A specific implementation of each of the preceding steps is described below.

Firstly, S10 is described below.

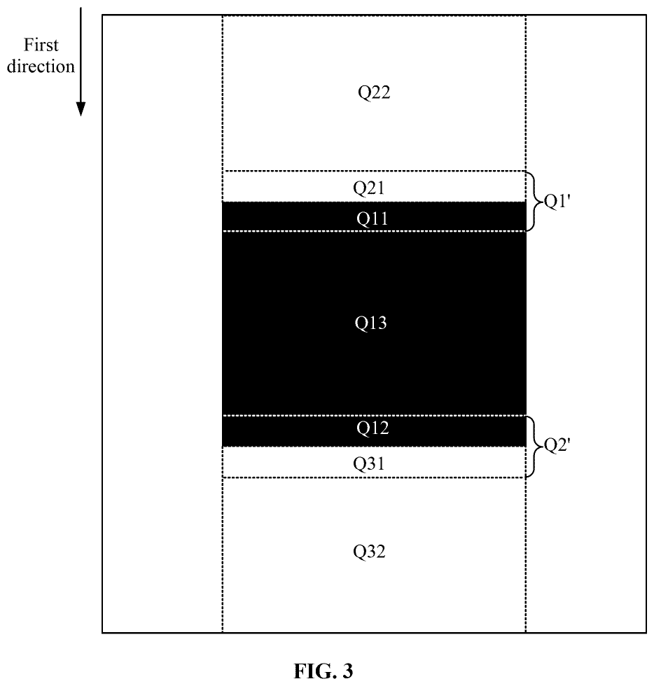

According to the to-be-displayed image, images that need to be displayed in different regions in the display panel may be determined. For example, as shown in FIG. 3, the images that need to be displayed in different regions in the display panel are determined according to the to-be-displayed image, where a black image needs to be displayed in a region Q1, and a white image needs to be displayed in a region outside the region Q1. For ease of description, the region above the region Q1 is marked as Q2, the region below the region Q1 is marked as Q3, and white images need to be displayed in the region Q2 and the region Q3.

It is to be noted that the display scenario shown in FIG. 3 is only an example and is not intended to limit the present application.

As shown in FIG. 3, the display panel may include multiple rows of pixels. An initial data voltage value of a pixel may be understood as a data voltage value that is written into the pixel before compensation. Different images need to be displayed in different regions, and the different regions have different initial data voltage values.

Charging time of data voltages of the pixel is different at different refresh rates. Therefore, at the different refresh rates, the same pixel may have different initial data voltage values.

In addition, for example, the coupling effect is caused by the line crosstalk in a region where a black image and a white image are joined. Therefore, an initial data voltage value of each of pixels that need to display the black image in the region with a black-and-white junction is different from an initial data voltage value of each of pixels that need to display the black image in the region with no black-and-white junction. Similarly, an initial data voltage value of each of pixels that need to display the white image in the region with the black-and-white junction is different from an initial data voltage value of each of pixels that need to display the white image in a region with no black-and-white junction.

For example, the display panel may be configured with a data driver. The data driver is configured to provide a data voltage to each pixel in a display region. Data voltages generated by the data driver for the to-be-displayed image may be read such that the initial data voltage value of each pixel in the display panel is determined.

Next, S20 is described below.

For example, as shown in FIG. 3, the region Q1 includes a region Q11, a region Q12, and a region Q13 that are arranged in a first direction D1, the region Q2 includes a region Q21 and a region Q22 that are arranged in the first direction D1, and the region Q3 includes a region Q31 and a region Q32 that are arranged in the first direction D1. The first direction D1 is a column direction.

A region Q1′ includes the region Q11 and the region Q21, and a region Q2′ includes the region Q12 and the region Q31. The region Q1′ may be understood as a first region with the black-and-white junction, and the region Q2′ may be understood as a second region with the black-and-white junction. The region 13, the region Q22, and the region Q32 may be understood as regions with no black-and-white junction.

Although the black image needs to be displayed in both the region Q11 and the region Q13, an initial data voltage value of each of pixels in the region Q11 is different from an initial data voltage value of each of pixels in the region Q13 due to the coupling effect caused by the line crosstalk between the region Q11 and the region Q21 and the like. Similarly, although the white image needs to be displayed in both the region Q21 and the region Q22, an initial data voltage value of each of pixels in the region Q21 is different from an initial data voltage value of each of pixels in the region Q22 due to the coupling effect caused by the line crosstalk between the region Q11 and the region Q21 and the like. In addition, an initial data voltage value of each of pixels in the region Q12 is different from an initial data voltage value of each of the pixels in the region Q13, and an initial data voltage value of each of pixels in the region Q31 is different from an initial data voltage value of each of pixels in the region Q32.

The to-be-compensated region in the display panel may be divided according to the initial data voltage value of each pixel. As shown in FIG. 3, the region Q1′ and the region Q2′ are to-be-compensated regions, where one of the region Q11 and the region Q21 is the first to-be-compensated region, the other is the second to-be-compensated region, one of the region Q12 and the region Q31 is the first to-be-compensated region, and the other is the second to-be-compensated region. For example, the region Q11 and the region Q12 where the black image needs to be displayed are first to-be-compensated regions, and the region Q21 and the region Q31 where the white image needs to be displayed are second to-be-compensated regions.

It is to be understood that in the case where the absolute value of the difference between the initial data voltage value of the first pixel in the first to-be-compensated region and the initial data voltage value of the second pixel in the second to-be-compensated region is larger, that is, the brightness difference between the image that needs to be displayed in the first to-be-compensated region and the image that needs to be displayed in the second to-be-compensated region is larger, coupling is more serious and causes a more apparent bright line or dark line; conversely, in the case where the absolute value of the difference between the initial data voltage value of the first pixel in the first to-be-compensated region and the initial data voltage value of the second pixel in the second to-be-compensated region is smaller, that is, the brightness difference between the image that needs to be displayed in the first to-be-compensated region and the image that needs to be displayed in the second to-be-compensated region is smaller, the coupling problem is alleviated and causes a less apparent bright line or dark line. Therefore, a value of the first threshold may be set with both compensation efficiency and compensation precision considered. For example, a data voltage value of a single grayscale is V0, and the first threshold may be set to the product of X1 grayscales and V0, where X1 is an integer greater than 0. It is to be understood that the smaller X1, the higher the compensation precision, and the larger X1, the higher the compensation efficiency.

Of course, the minimum value of the difference between the data voltages in the regions with the black-and-white junctions in the case where the bright line or the dark line appears may also be determined through a simulation experiment, and the minimum value is used as the first threshold.

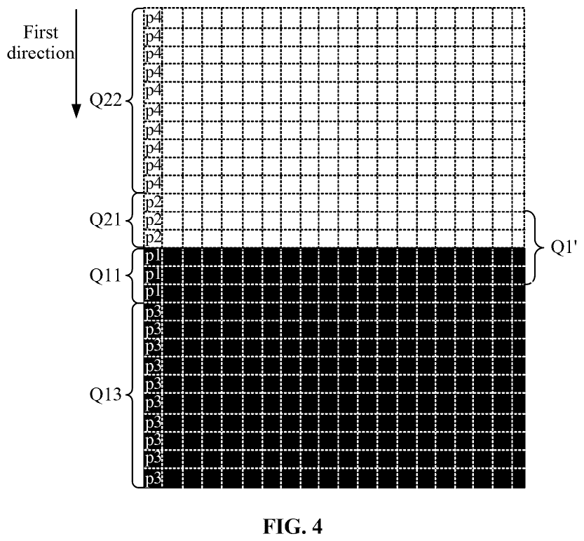

In some embodiments, as shown in FIG. 4 that is an enlarged schematic diagram of the regions Q22, Q21, Q11, and Q13 in FIG. 3, using an example in which the first to-be-compensated region is the region Q11 and the second to-be-compensated region is the region Q21, the first to-be-compensated region Q11 includes multiple first pixels P1, and the second to-be-compensated region Q21 includes multiple second pixels P2.

Although the black image needs to be displayed by all of the multiple first pixels P1, the initial data voltage values of the multiple first pixels P1 may be slightly different due to different positions and different coupling effects caused by the line crosstalk or other reasons. Similarly, although the white image needs to be displayed by all of the multiple second pixels P2, the initial data voltage values of the multiple second pixels P2 may be slightly different due to different positions and different coupling effects caused by the line crosstalk or other reasons.

For example, the average value of the initial data voltage values of the multiple first pixels P1 is a first average value, and the first average value may be used as an initial data voltage value corresponding to the first to-be-compensated region Q11. The average value of the initial data voltage values of the multiple second pixels P2 is a second average value, and the second average value may be used as an initial data voltage value corresponding to the second to-be-compensated region Q21.

In S20 mentioned above, the absolute value of the difference between the initial data voltage value of the first pixel in the first to-be-compensated region and the initial data voltage value of the second pixel in the second to-be-compensated region is larger than the first threshold, which may include the following case: the absolute value of the difference between the first average value and the second average value is larger than the first threshold.

In the embodiment of the present application, the average value of the initial data voltage values of the multiple pixels in the to-be-compensated region is used as the initial data voltage value of the to-be-compensated region so that actual situations of the multiple pixels can be considered, thereby achieving a better compensation effect.

When the black-and-white junction appears in a display scenario, a whole row of pixels by which the black image needs to be displayed and a whole row of pixels by which the white image needs to be displayed tend to be subjected to abnormal brightness in the region with the black-and-white junction. Thus, the bright line or the dark line appears in the whole row in the region with the black-and-white junction.

In some embodiments, as shown in FIG. 4, the multiple first pixels P1 are distributed in m rows, and the multiple second pixels P2 are distributed in n rows, where m and n are integers greater than 0. In this way, the first pixels distributed in a whole row and the second pixels distributed in a whole row may be compensated as to-be-compensated pixels, thereby achieving a better compensation effect.

When the black-and-white junction appears in the display scenario, not only a black row and a white row that are the most adjacent to each other are subjected to the line crosstalk, but also multiple adjacent rows may be subjected to the line crosstalk to a certain extent.

In some embodiments, both m and n are integers greater than or equal to 2. In this way, the first pixels in the multiple rows and the second pixels in the multiple rows may be compensated as to-be-compensated pixels, thereby achieving a better compensation effect.

When the black-and-white junction appears in the display scenario, in the region with the black-and-white junction, the number of rows of pixels by which the black image needs to be displayed and which are affected by the coupling tends to be the same as the number of rows of pixels by which the white image needs to be displayed and which are affected by the coupling. In some embodiments, m=n. For example, m=n=4, and four rows of first pixels P1 and four rows of second pixels P2 are the to-be-compensated pixels.

For example, a value of m and a value of n may be set according to the compensation capability of a driver chip and the resolution of the display panel.

Then, S30 is described below.

As shown in FIG. 4, the average value of the initial data voltage values of the multiple first pixels P1 is the first average value, and the average value of the initial data voltage values of the multiple second pixels P2 is the second average value.

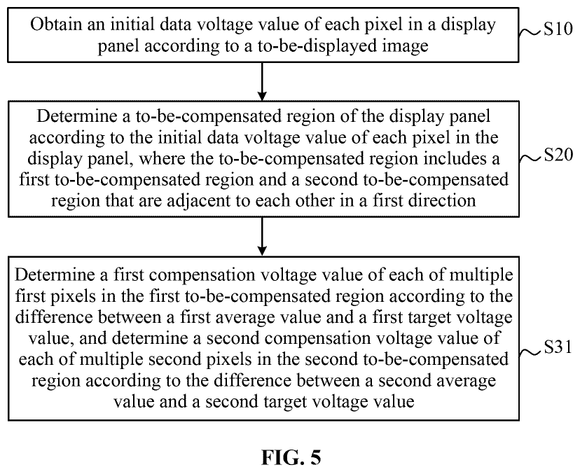

In some embodiments, as shown in FIG. 5, S30 may include S31.

In S31, a first compensation voltage value of each of the multiple first pixels in the first to-be-compensated region is determined according to the difference between the first average value and the first target voltage value, and a second compensation voltage value of each of the multiple second pixels in the second to-be-compensated region is determined according to the difference between the second average value and the second target voltage value.

In the embodiment of the present application, the difference between the first average value and the first target voltage value may be used as the first compensation voltage value of each of the multiple first pixels in the first to-be-compensated region, and the multiple first pixels have the same compensation voltage value, and the difference between the second average value and the second target voltage value may be used as the second compensation voltage value of each of the multiple second pixels in the second to-be-compensated region, and the multiple second pixels have the same compensation voltage value.

The difference between the initial data voltage values of the multiple first pixels in the first to-be-compensated region is not too large. Therefore, the same compensation voltage value is sampled to compensate for the multiple first sub-pixels, which does not affect a visual effect. Similarly, the difference between the initial data voltage values of the multiple second pixels in the second to-be-compensated region is not too large. Therefore, the same compensation voltage value is sampled to compensate for the multiple second sub-pixels, which does not affect the visual effect. In this way, compensation logic can be simplified, and the compensation efficiency can be improved.

The sum of the initial data voltage value of the first pixel and the first compensation voltage value is a compensated data voltage value of the first pixel. The sum of the initial data voltage value of the second pixel and the second compensation voltage value is a compensated data voltage value of the second pixel. The first compensation voltage value and the second compensation voltage value may be positive or negative numbers.

Different images need to be displayed in the first to-be-compensated region and the second to-be-compensated region. Therefore, the first target voltage value and the second target voltage value to which the first to-be-compensated region and the second to-be-compensated region respectively correspond are different from each other. Exemplary description is made below to a manner in which the first target voltage value and the second target voltage value are determined.

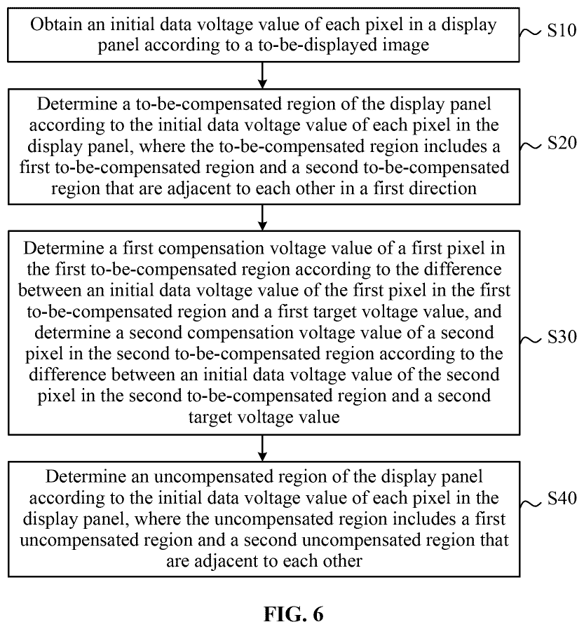

In some embodiments, as shown in FIG. 6, the display panel compensation method provided in the embodiment of the present application may further include S40.

In S40, an uncompensated region of the display panel is determined according to the initial data voltage value of each pixel in the display panel, where the uncompensated region includes a first uncompensated region and a second uncompensated region that are adjacent to each other, the first uncompensated region and the first to-be-compensated region are adjacent to each other in the first direction, the second uncompensated region and the second to-be-compensated region are adjacent to each other in the first direction, the absolute value of the difference between the initial data voltage value of the first pixel in the first to-be-compensated region and an initial data voltage value of a third pixel in the first uncompensated region is smaller than a second threshold, and the absolute value of the difference between the initial data voltage value of the second pixel in the second to-be-compensated region and an initial data voltage value of a fourth pixel in the second uncompensated region is smaller than a third threshold, where the first threshold is greater than the second threshold, and the first threshold is greater than the third threshold.

In the embodiment of the present application, the uncompensated regions are determined and no compensation may be performed on the uncompensated regions so that the amount of data that needs to be compensated may be reduced, thereby helping to improve the compensation efficiency.

For example, referring to FIG. 3, the white image needs to be displayed in both the region Q22 and the region Q21. No apparent black-and-white junction is needed between the region Q22 and the region Q21. Therefore, no significant line crosstalk exists between the region Q22 and the region Q21. The region Q22 may be used as the uncompensated region.

Similarly, the black image needs to be displayed in all of the region 11, the region 12, and the region Q13. No apparent black-and-white junction is needed between the region Q13 and the region Q11 and between the region Q13 and the region Q12. Therefore, no significant line crosstalk exists between the region Q13 and the region Q11 and between the region Q13 and the region Q12. The region Q13 may be used as the uncompensated region.

As shown in FIG. 3, the region Q11 is the first to-be-compensated region, the region Q13 is the first uncompensated region, the region Q21 is the second to-be-compensated region, the region Q22 is the second uncompensated region, the black image needs to be displayed in both the region Q11 and the region Q13, and the black image needs to be displayed in both the region Q21 and the region Q22. Thus, the difference between the initial data voltage value of the region Q11 and the initial data voltage value of the region Q13 is much smaller than the difference between the initial data voltage value of the region Q11 and the initial data voltage value of the region Q21. Similarly, the difference between the initial data voltage value of the region Q21 and the initial data voltage value of the region Q22 is much smaller than the difference between the initial data voltage value of the region Q11 and the initial data voltage value of the region Q21. Therefore, the second threshold may be much less than the first threshold, and the third threshold may be much less than the first threshold.

For example, still using an example in which the data voltage value of the single grayscale is V0, the first threshold may be set to the product of X1 grayscales and V0, where X1 is the integer greater than 0, the second threshold may be set to the product of X2 grayscales and V0, where X2 may be an integer greater than 0, and the third threshold may be set to the product of X3 grayscales and V0, where X3 may be an integer greater than 0. Each of X2 and X3 may be much less than X1. For example, X1 may be approximately 240 grayscales, and each of X2 and X3 may be approximately 5 grayscales.

In some embodiments, with continued reference to FIG. 4, using an example in which the first to-be-compensated region is the region Q11, the second to-be-compensated region is the region Q21, the first uncompensated region is the region Q13, and the second uncompensated region is the region Q22, the first to-be-compensated region Q11 includes the multiple first pixels P1, the second to-be-compensated region Q21 includes the multiple second pixels P2, the first uncompensated region Q13 includes multiple third pixels P3, and the second uncompensated region Q22 includes multiple fourth pixels P4.

Although the black image needs to be displayed by all of the multiple first pixels P1, the initial data voltage values of the multiple first pixels P1 may be slightly different due to the different positions and the different coupling effects caused by the line crosstalk or other reasons. Similarly, although the white image needs to be displayed by all of the multiple second pixels P2, the initial data voltage values of the multiple second pixels P2 may be slightly different due to the different positions and the different coupling effects caused by the line crosstalk or other reasons.

In addition, although the black image needs to be displayed by all of the multiple third pixels P3, the initial data voltage values of the multiple third pixels P3 may be slightly different due to different positions and other reasons. Similarly, the initial data voltage values of the multiple fourth pixels P4 may be slightly different.

For example, the average value of the initial data voltage values of the multiple first pixels P1 is the first average value, and the first average value may be used as the initial data voltage value corresponding to the first to-be-compensated region Q11. The average value of the initial data voltage values of the multiple second pixels P2 is the second average value, and the second average value may be used as the initial data voltage value corresponding to the second to-be-compensated region Q21.

The average value of the initial data voltage values of the multiple third pixels P3 is a third average value, and the third average value may be used as an initial data voltage value corresponding to the first uncompensated region Q13. The average value of the initial data voltage values of the multiple fourth pixels P4 is a fourth average value, and the fourth average value may be used as an initial data voltage value corresponding to the second uncompensated region Q22.

In S40 mentioned above, the absolute value of the difference between the initial data voltage value of the first pixel in the first to-be-compensated region and the initial data voltage value of the third pixel in the first uncompensated region is smaller than the second threshold, which includes the following case: the absolute value of the difference between the first average value and the third average value is smaller than the second threshold.

In S40 mentioned above, the absolute value of the difference between the initial data voltage value of the second pixel in the second to-be-compensated region and the initial data voltage value of the fourth pixel in the second uncompensated region is smaller than the third threshold, which includes the following case: the absolute value of the difference between the second average value and the fourth average value is smaller than the third threshold.

In the embodiment of the present application, the average value of the initial data voltage values of the multiple pixels in the to-be-compensated region is used as the initial data voltage value of the to-be-compensated region and the average value of the initial data voltage values of the multiple pixels in the uncompensated region is used as the initial data voltage value of the uncompensated region so that actual situations of the multiple pixels can be considered, thereby achieving a better division effect and a better compensation effect.

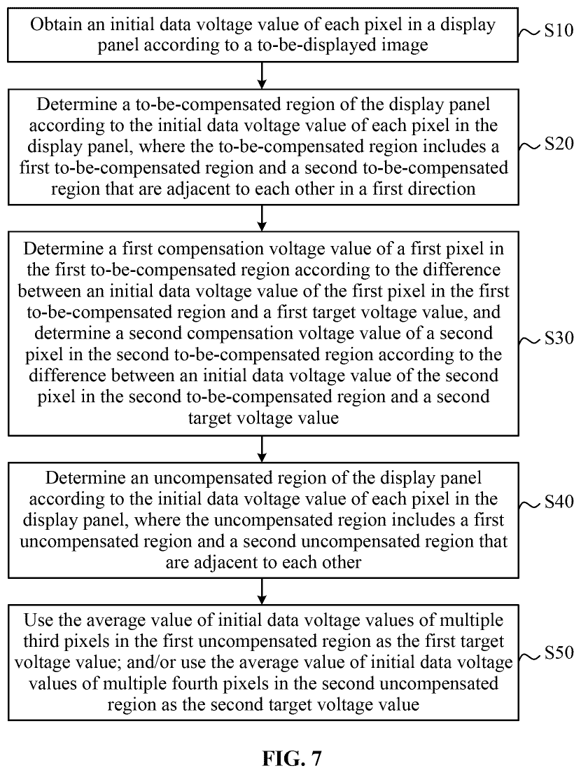

In some embodiments, as shown in FIG. 7, the display panel compensation method provided in the embodiment of the present application may further include S50.

In S50, the average value of the initial data voltage values of the multiple third pixels in the first uncompensated region is used as the first target voltage value; and/or the average value of the initial data voltage values of the multiple fourth pixels in the second uncompensated region is used as the second target voltage value.

In theory, the same image (for example, the black image) with consistent brightness needs to be displayed in the first uncompensated region and the first to-be-compensated region. The average value of the initial data voltage values of the multiple third pixels in the first uncompensated region is used as the first target voltage value so that the brightness of the first to-be-compensated region after the compensation tends to be consistent with the brightness of the first uncompensated region, thereby alleviating the problem of the bright line or the dark line. Similarly, in theory, the same image (for example, the white image) with consistent brightness needs to be displayed in the second uncompensated region and the second to-be-compensated region. The average value of the initial data voltage values of the multiple fourth pixels in the second uncompensated region is used as the second target voltage value so that the brightness of the second to-be-compensated region after the compensation tends to be consistent with the brightness of the second uncompensated region, thereby alleviating the problem of the bright line or the dark line.

Of course, in another example, for example, a specific value of the first target voltage value and a specific value of the second target voltage value may be set according to experience or actual requirements.

In some embodiments, the first to-be-compensated region includes the multiple first pixels, and the second to-be-compensated region includes the multiple second pixels. The difference between the initial data voltage values of the multiple first pixels is less than a fourth threshold, and the difference between the initial data voltage values of the multiple second pixels is less than a fifth threshold, where the first threshold is greater than the fourth threshold, and the first threshold is greater than the fifth threshold.

The same image (for example, the black image) needs to be displayed by all of the multiple first pixels. Therefore, even if the difference exists between the initial data voltage values of the multiple first pixels, the difference is relatively small. The same image (for example, the white image) needs to be displayed by all of the multiple second pixels. Therefore, even if the difference exists between the initial data voltage values of the multiple second pixels, the difference is relatively small. Therefore, the fourth threshold may be much less than the first threshold, and the fifth threshold may be much less than the first threshold.

For example, still using the example in which the data voltage value of the single grayscale is V0, the first threshold may be set to the product of X1 grayscales and V0, where X1 is the integer greater than 0, the fourth threshold may be set to the product of X4 grayscales and V0, where X4 may be an integer greater than 0, and the fifth threshold may be set to the product of X5 grayscales and V0, where X5 may be an integer greater than 0. Each of X4 and X5 may be much less than X1. For example, X1 may be approximately 240 grayscales, and each of X4 and X5 may be approximately 5 grayscales.

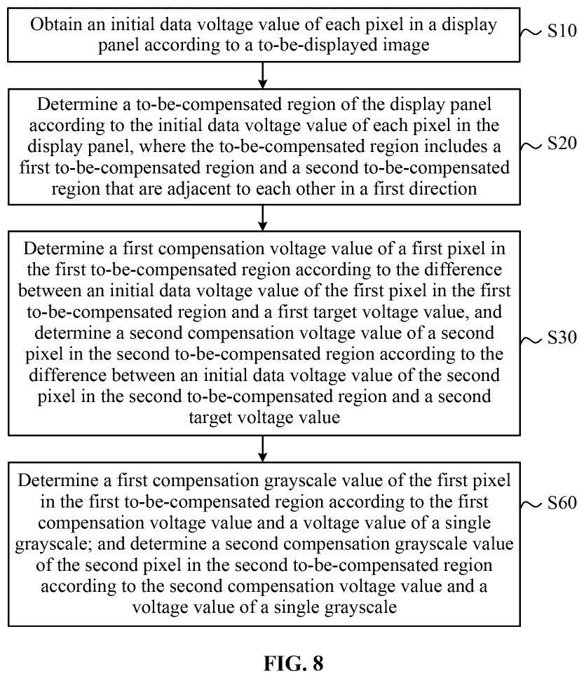

In some embodiments, as shown in FIG. 8, the display panel compensation method provided in the embodiment of the present application may further include S60.

In S60, a first compensation grayscale value of the first pixel in the first to-be-compensated region is determined according to the first compensation voltage value and a voltage value of a single grayscale;

A second compensation grayscale value of the second pixel in the second to-be-compensated region is determined according to the second compensation voltage value and a voltage value of a single grayscale.

In a display process, the acquired data of the to-be-displayed image is an initial grayscale value of each pixel. After a compensation grayscale value is determined, the sum of the initial grayscale value and the compensation grayscale value may be directly used as a compensated grayscale value, then a data voltage may be generated based on the compensated grayscale value, and the pixel is driven to emit light.

Each of the first compensation grayscale value and the second compensation grayscale value may be an integer or a negative number.

In some embodiments, the voltage value of the single grayscale is V0, and V0=(Vmax−Vmin)/Gmax.

Gmax denotes the maximum grayscale value of the display panel, Vmax denotes the maximum data voltage value of the display panel, and Vmin denotes the minimum data voltage value of the display panel.

For example, if the maximum grayscale value Gmax of the display panel is 255, Vmax is 7.0 V, and Vmin is 0.5 V, V0=(7.0−0.5)/255.

It is to be noted that the application scenario described in the preceding embodiment of the present application is intended to more clearly describe the technical solution in the embodiment of the present application, and does not constitute a limitation on the technical solution provided in the embodiment of the present application. Those of ordinary skill in the art may know that the technical solution provided in the embodiment of the present application is also applicable to a similar technical problem with the emergence of a new application scenario.

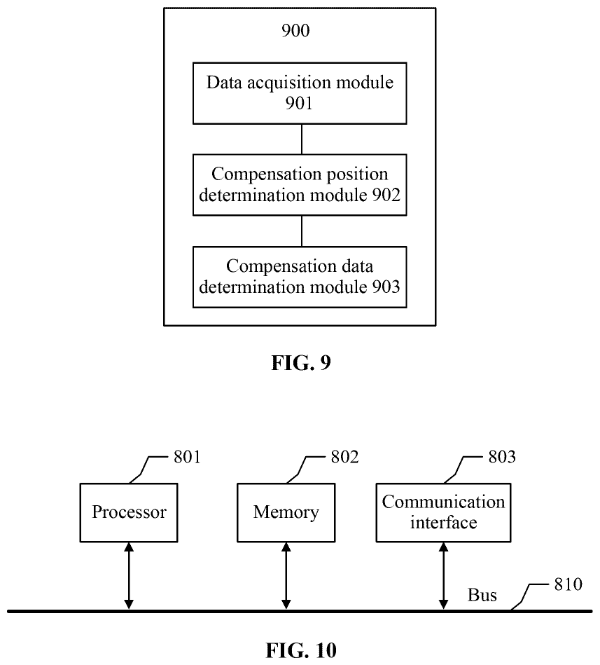

Based on the same inventive concept, the present application further provides a display panel compensation apparatus. Detailed description is performed in conjunction with FIG. 9.

FIG. 9 is a structural diagram of a display panel compensation apparatus according to an embodiment of the present application. As shown in FIG. 9, a display panel compensation apparatus 900 provided in the embodiment of the present application may include a data acquisition module 901, a compensation position determination module 902, and a compensation data determination module 903.

The data acquisition module 901 is configured to obtain an initial data voltage value of each pixel in a display panel according to a to-be-displayed image.

The compensation position determination module 902 is configured to determine a to-be-compensated region of the display panel according to the initial data voltage value of each pixel in the display panel, where the to-be-compensated region includes a first to-be-compensated region and a second to-be-compensated region that are adjacent to each other in a first direction, and the absolute value of the difference between an initial data voltage value of a first pixel in the first to-be-compensated region and an initial data voltage value of a second pixel in the second to-be-compensated region is larger than a first threshold.

The compensation data determination module 903 is configured to determine a first compensation voltage value of the first pixel in the first to-be-compensated region according to the difference between the initial data voltage value of the first pixel in the first to-be-compensated region and a first target voltage value and determine a second compensation voltage value of the second pixel in the second to-be-compensated region according to the difference between the initial data voltage value of the second pixel in the second to-be-compensated region and a second target voltage value.

According to the display panel compensation apparatus provided in the embodiment of the present application, the initial data voltage value of the pixel is obtained according to the actual to-be-displayed image, then the to-be-compensated region is determined based on the initial data voltage value of the pixel, and the compensation voltage value of the pixel in the to-be-compensated region is determined according to the difference between the initial data voltage value of the pixel in the to-be-compensated region and the target voltage value. At different refresh rates, the initial data voltage value may be different, and further, the obtained compensation voltage value may be different. In this way, compensation in different scenarios may no longer be performed based on one fixed compensation value, thereby implementing dynamic compensation.

In some embodiments, the first to-be-compensated region includes multiple first pixels, and the second to-be-compensated region includes multiple second pixels.

The average value of initial data voltage values of the multiple first pixels is a first average value.

The average value of initial data voltage values of the multiple second pixels is a second average value.

The absolute value of the difference between the first average value and the second average value is larger than the first threshold.

In some embodiments, the multiple first pixels are distributed in m rows, and the multiple second pixels are distributed in n rows, where m and n are integers greater than 0.

In some embodiments, m and n are integers greater than or equal to 2.

In some embodiments, m=n.

In some embodiments, the compensation data determination module 903 is configured to:
determine a first compensation voltage value of each of the multiple first pixels in the first to-be-compensated region according to the difference between the first average value and the first target voltage value; and
determine a second compensation voltage value of each of the multiple second pixels in the second to-be-compensated region according to the difference between the second average value and the second target voltage value.

In some embodiments, the compensation position determination module 902 is further configured to:
determine an uncompensated region of the display panel according to the initial data voltage value of each pixel in the display panel, where the uncompensated region includes a first uncompensated region and a second uncompensated region that are adjacent to each other, the first uncompensated region and the first to-be-compensated region are adjacent to each other in the first direction, the second uncompensated region and the second to-be-compensated region are adjacent to each other in the first direction, the absolute value of the difference between the initial data voltage value of the first pixel in the first to-be-compensated region and an initial data voltage value of a third pixel in the first uncompensated region is smaller than a second threshold, and the absolute value of the difference between the initial data voltage value of the second pixel in the second to-be-compensated region and an initial data voltage value of a fourth pixel in the second uncompensated region is smaller than a third threshold, where the first threshold is greater than the second threshold, and the first threshold is greater than the third threshold.

In some embodiments, the first to-be-compensated region includes multiple first pixels, the second to-be-compensated region includes multiple second pixels, the first uncompensated region includes multiple third pixels, and the second uncompensated region includes multiple fourth pixels.

The average value of initial data voltage values of the multiple first pixels is a first average value.

The average value of initial data voltage values of the multiple second pixels is a second average value.

The average value of initial data voltage values of the multiple third pixels is a third average value.

The average value of initial data voltage values of the multiple fourth pixels is a fourth average value.

The absolute value of the difference between the first average value and the third average value is smaller than the second threshold.

The absolute value of the difference between the second average value and the fourth average value is smaller than the third threshold.

In some embodiments, the compensation data determination module 903 is configured to:
use the average value of initial data voltage values of multiple third pixels in the first uncompensated region as a first target voltage value;
and/or
use the average value of initial data voltage values of multiple fourth pixels in the second uncompensated region as a second target voltage value.

In some embodiments, the first to-be-compensated region includes multiple first pixels, and the second to-be-compensated region includes multiple second pixels.

The difference between initial data voltage values of the multiple first pixels is less than a fourth threshold.

The difference between initial data voltage values of the multiple second pixels is less than a fifth threshold.

The first threshold is greater than the fourth threshold, and the first threshold is greater than the fifth threshold.

In some embodiments, the compensation data determination module 903 is further configured to:
determine a first compensation grayscale value of the first pixel in the first to-be-compensated region according to the first compensation voltage value and a voltage value of a single grayscale; and
determine a second compensation grayscale value of the second pixel in the second to-be-compensated region according to the second compensation voltage value and a voltage value of a single grayscale.

In some embodiments, the voltage value of the single grayscale is V0, and V0=(Vmax−Vmin)/Gmax.

Gmax denotes the maximum grayscale value of the display panel, Vmax denotes the maximum data voltage value of the display panel, and Vmin denotes the minimum data voltage value of the display panel.

It is to be noted that the display panel compensation method provided in the embodiment of the present application may be performed by the display panel compensation apparatus or a control module that is in the display panel compensation apparatus and is configured to perform the display panel compensation method. In the embodiment of the present application, using an example in which the display panel compensation apparatus performs the display panel compensation method, the display panel compensation apparatus provided in the embodiment of the present application is described.

The display panel compensation apparatus in the embodiment of the present application may be an apparatus or may be a component, an integrated circuit, or a chip in a terminal. The apparatus may be a mobile electronic device or a non-mobile electronic device. For example, the mobile electronic device may be a mobile phone, a tablet computer, a notebook computer, a palmtop computer, an in-vehicle electronic device, a wearable device, an ultra-mobile personal computer (UMPC), a netbook, a personal digital assistant (PDA), or the like, and the non-mobile electronic device may be a server, a network attached storage (NAS), a personal computer (PC), a television (TV), a teller machine, a self-service machine, or the like, which are not specifically limited in the embodiment of the present application.

The display panel compensation apparatus provided in the embodiment of the present application can implement processes in the embodiment of the display panel compensation method shown in FIG. 2. For avoiding repetition, the details are not repeated here.

FIG. 10 shows a schematic diagram of a hardware structure of an electronic device according to an embodiment of the present application.

The electronic device may include a processor 801 and a memory 802 that stores a computer program instruction.

Specifically, the preceding processor 801 may include a central processing unit (CPU) or an application-specific integrated circuit (ASIC), or may be configured to be one or more integrated circuits implementing the embodiment of the present application.

The memory 802 may include a mass storage for data or instructions. For example and without limitation, the memory 802 may include a hard disk drive (HDD), a floppy disk drive, a flash memory, an optical disk, a magneto-optical disk, a magnetic tape, or a universal serial bus (USB) drive, or a combination of two or more thereof. Where appropriate, the memory 802 may include a removable or non-removable (or fixed) medium. Where appropriate, the memory 802 may be inside or outside a comprehensive gateway disaster recovery device. In a particular embodiment, the memory 802 is a non-volatile solid-state memory.

In a particular embodiment, the memory 802 includes a read-only memory (ROM). Where appropriate, the ROM may be a mask-programmed ROM, a programmable ROM (PROM), an erasable PROM (EPROM), an electrically erasable PROM (EEPROM), an electrically rewriteable ROM (EAROM), or a flash memory, or a combination of two or more thereof. For example, the memory may include a non-volatile transitory memory.

The processor 801 may implement any display panel compensation method in the preceding embodiments by reading and executing the computer program instruction stored in the memory 802.

In an example, the electronic device may further include a communication interface 803 and a bus 810. As shown in FIG. 10, the processor 801, the memory 802, and the communication interface 803 are connected through the bus 810 and communicate with each other.

The communication interface 803 is mainly configured to implement communication between various modules, apparatuses, units, and/or devices in the embodiments of the present invention.

The bus 810 includes hardware, software, or both, and couples the components of the electronic device. By way of example and without limitation, the bus may include an accelerated graphics port (AGP) or other graphics bus, an enhanced industry standard architecture (EISA) bus, a front-side bus (FSB), a HyperTransport (HT) interconnection, an industry standard architecture (ISA) bus, an unlimited bandwidth interconnection, a Low Pin Count (LPC) bus, a memory bus, a microchannel architecture (MCA) bus, a peripheral component interconnection (PCI) bus, a PCI-Express (PCI-X) bus, a serial advanced technology attachment (SATA) bus, a video electronics standards association local (VLB) bus or other suitable bus, or a combination of two or more thereof. Where appropriate, the bus 810 may include one or more buses. Although the embodiment of the present invention describes and shows a specific bus, the present invention considers any suitable bus or interconnection.

For example, the electronic device 800 may be a mobile phone, a tablet computer, a notebook computer, a palmtop computer, an in-vehicle electronic device, a UMPC, a netbook, a PDA, or the like.

The electronic device may perform the display panel compensation method in the embodiment of the present application so that the display panel compensation method and the display panel compensation apparatus described in conjunction with FIG. 2 and FIG. 9 are implemented.

An embodiment of the present application further provides a computer-readable storage medium configured to store a computer program. When executing the computer program, a processor may implement the display panel compensation method in the preceding embodiment, and the same technical effect can be achieved. For avoiding repetition, the details are not repeated here. The preceding computer-readable storage medium may include a ROM, a random-access memory (RAM), a magnetic disk, or an optical disk, which is not limited herein.

It is to be noted that the present application is not limited to the specific configurations and processing described above and shown in the figures. For the sake of brevity, detailed descriptions of known methods are omitted here. In the preceding embodiments, several specific steps are described and shown as examples. However, the method processes of the present application are not limited to the described and shown specific steps, and those skilled in the art may make various changes, modifications, and additions or change the order of the steps after comprehending spirits of the present application.

Functional blocks shown in the preceding structural block diagrams may be implemented as hardware, software, firmware, or a combination thereof. When implemented as the hardware, a functional block may be, for example, an electronic circuit, an ASIC, suitable firmware, a plug-in, a function card, or the like. When implemented as the software, such elements of the present application may be programs or code segments for performing the required tasks. The programs or code segments may be stored in a machine-readable medium or transmitted over a transmission medium or a communication link by data signals carried in carrier waves. The “computer-readable medium” may include any medium capable of storing or transmitting information. Examples of the computer-readable medium may include an electronic circuit, a semiconductor memory device, a ROM, a flash memory, an erasable ROM (EROM), a floppy disk, a CD-ROM, an optical disk, a hard disk, an optical fiber medium, a radio frequency (RF) link, and the like. The code segments may be downloaded via a computer network such as the Internet, an intranet, or the like.

According to the embodiment of the present application, the computer-readable storage medium may be a non-transitory computer-readable storage medium.

It is also to be noted that the example embodiments mentioned in the present application describe some methods or systems based on a series of steps or apparatuses. However, the present application is not limited to the order of the steps, that is to say, the steps may be performed in the order mentioned in the embodiments, or in an order different from the order mentioned in the embodiments, or several steps may be performed simultaneously.

Various aspects of the present application have been described above with reference to flowcharts and/or block diagrams of the methods, apparatuses (systems) and computer program products according to the embodiments of the present application. It is to be understood that each block in the flowcharts and/or the block diagrams and a combination of the blocks in the flowcharts and/or the block diagrams may be implemented by computer program instructions. These computer program instructions may be provided for a processor of a general-purpose computer, a special-purpose computer, or other programmable data processing apparatus to produce a machine so that these computer program instructions to be executed via the processor of the computer or other programmable data processing apparatus can implement functions/actions specified in one or more of the blocks in the flowcharts and/or the block diagrams. The processor may be, but is not limited to, a general-purpose processor, a special-purpose processor, an application-specific processor, or a field-programmable logic circuit. It is also to be understood that each block in the block diagrams and/or the flowcharts and a combination of the blocks in the block diagrams and/or the flowcharts may be implemented by special-purpose hardware that performs the specified functions or actions, or may be implemented by a combination of special-purpose hardware and computer instructions.

What is claimed is:

1. A display panel compensation method, comprising:
obtaining an initial data voltage value of each pixel in a display panel according to a to-be-displayed image;
determining a to-be-compensated region of the display panel according to the initial data voltage value of each pixel in the display panel, wherein the to-be-compensated region comprises a first to-be-compensated region and a second to-be-compensated region that are adjacent to each other in a first direction, and an absolute value of a difference between an initial data voltage value of a first pixel in the first to-be-compensated region and an initial data voltage value of a second pixel in the second to-be-compensated region is larger than a first threshold; and
determining a first compensation voltage value of the first pixel in the first to-be-compensated region according to a difference between the initial data voltage value of the first pixel in the first to-be-compensated region and a first target voltage value; and
determining a second compensation voltage value of the second pixel in the second to-be-compensated region according to a difference between the initial data voltage value of the second pixel in the second to-be-compensated region and a second target voltage value.

2. The display panel compensation method according to claim 1, wherein the first to-be-compensated region comprises a plurality of first pixels, and the second to-be-compensated region comprises a plurality of second pixels;
wherein an average value of initial data voltage values of the plurality of first pixels is a first average value;
an average value of initial data voltage values of the plurality of second pixels is a second average value; and
an absolute value of a difference between the first average value and the second average value is larger than the first threshold.

3. The display panel compensation method according to claim 2, wherein the plurality of first pixels are distributed in m rows, and the plurality of second pixels are distributed in n rows, wherein m and n are integers greater than 0.

4. The display panel compensation method according to claim 3, wherein m and n are integers greater than or equal to 2.

5. The display panel compensation method according to claim 3, wherein m=n.

6. The display panel compensation method according to claim 2, wherein determining the first compensation voltage value of the first pixel in the first to-be-compensated region according to the difference between the initial data voltage value of the first pixel in the first to-be-compensated region and the first target voltage value comprises:
determining a first compensation voltage value of each of the plurality of first pixels in the first to-be-compensated region according to a difference between the first average value and the first target voltage value; and
wherein determining the second compensation voltage value of the second pixel in the second to-be-compensated region according to the difference between the initial data voltage value of the second pixel in the second to-be-compensated region and the second target voltage value comprises:
determining a second compensation voltage value of each of the plurality of second pixels in the second to-be-compensated region according to a difference between the second average value and the second target voltage value.

7. The display panel compensation method according to claim 1, further comprising:
determining an uncompensated region of the display panel according to the initial data voltage value of each pixel in the display panel, wherein the uncompensated region comprises a first uncompensated region and a second uncompensated region that are adjacent to each other, the first uncompensated region and the first to-be-compensated region are adjacent to each other in the first direction, the second uncompensated region and the second to-be-compensated region are adjacent to each other in the first direction, an absolute value of a difference between the initial data voltage value of the first pixel in the first to-be-compensated region and an initial data voltage value of a third pixel in the first uncompensated region is smaller than a second threshold, and an absolute value of a difference between the initial data voltage value of the second pixel in the second to-be-compensated region and an initial data voltage value of a fourth pixel in the second uncompensated region is smaller than a third threshold, wherein the first threshold is greater than the second threshold, and the first threshold is greater than the third threshold.

8. The display panel compensation method according to claim 7, wherein the first to-be-compensated region comprises a plurality of first pixels, the second to-be-compensated region comprises a plurality of second pixels, the first uncompensated region comprises a plurality of third pixels, and the second uncompensated region comprises a plurality of fourth pixels;
wherein an average value of initial data voltage values of the plurality of first pixels is a first average value;
an average value of initial data voltage values of the plurality of second pixels is a second average value;
an average value of initial data voltage values of the plurality of third pixels is a third average value; and
an average value of initial data voltage values of the plurality of fourth pixels is a fourth average value;
wherein an absolute value of a difference between the first average value and the third average value is smaller than the second threshold; and
an absolute value of a difference between the second average value and the fourth average value is smaller than the third threshold.

9. The display panel compensation method according to claim 7, further comprising:
using an average value of initial data voltage values of a plurality of third pixels in the first uncompensated region as a first target voltage value;
and/or
using an average value of initial data voltage values of a plurality of fourth pixels in the second uncompensated region as a second target voltage value.

10. The display panel compensation method according to claim 1, wherein the first to-be-compensated region comprises a plurality of first pixels, and the second to-be-compensated region comprises a plurality of second pixels;
wherein a difference between initial data voltage values of the plurality of first pixels is less than a fourth threshold; and
a difference between initial data voltage values of the plurality of second pixels is less than a fifth threshold;
wherein the first threshold is greater than the fourth threshold, and the first threshold is greater than the fifth threshold.

11. The display panel compensation method according to claim 1, further comprising:
determining a first compensation grayscale value of the first pixel in the first to-be-compensated region according to the first compensation voltage value and a voltage value of a single grayscale; and
determining a second compensation grayscale value of the second pixel in the second to-be-compensated region according to the second compensation voltage value and a voltage value of a single grayscale.

12. The display panel compensation method according to claim 11, wherein the voltage value of the single grayscale is V0, and V0=(Vmax−Vmin)/Gmax;
wherein Gmax denotes a maximum grayscale value of the display panel, Vmax denotes a maximum data voltage value of the display panel, and Vmin denotes a minimum data voltage value of the display panel.

13. An electronic device, comprising:
a processor and a memory that stores a computer program instruction, wherein when executing the computer program instruction, the processor implements a display panel compensation method;
wherein the display panel compensation method comprises:
obtaining an initial data voltage value of each pixel in a display panel according to a to-be-displayed image;
determining a to-be-compensated region of the display panel according to the initial data voltage value of each pixel in the display panel, wherein the to-be-compensated region comprises a first to-be-compensated region and a second to-be-compensated region that are adjacent to each other in a first direction, and an absolute value of a difference between an initial data voltage value of a first pixel in the first to-be-compensated region and an initial data voltage value of a second pixel in the second to-be-compensated region is larger than a first threshold; and
determining a first compensation voltage value of the first pixel in the first to-be-compensated region according to a difference between the initial data voltage value of the first pixel in the first to-be-compensated region and a first target voltage value; and
determining a second compensation voltage value of the second pixel in the second to-be-compensated region according to a difference between the initial data voltage value of the second pixel in the second to-be-compensated region and a second target voltage value.

14. The electronic device according to claim 13, wherein the first to-be-compensated region comprises a plurality of first pixels, and the second to-be-compensated region comprises a plurality of second pixels;
wherein an average value of initial data voltage values of the plurality of first pixels is a first average value;
an average value of initial data voltage values of the plurality of second pixels is a second average value; and
an absolute value of a difference between the first average value and the second average value is larger than the first threshold.

15. The electronic device according to claim 13, wherein the display panel compensation method further comprises:
determining an uncompensated region of the display panel according to the initial data voltage value of each pixel in the display panel, wherein the uncompensated region comprises a first uncompensated region and a second uncompensated region that are adjacent to each other, the first uncompensated region and the first to-be-compensated region are adjacent to each other in the first direction, the second uncompensated region and the second to-be-compensated region are adjacent to each other in the first direction, an absolute value of a difference between the initial data voltage value of the first pixel in the first to-be-compensated region and an initial data voltage value of a third pixel in the first uncompensated region is smaller than a second threshold, and an absolute value of a difference between the initial data voltage value of the second pixel in the second to-be-compensated region and an initial data voltage value of a fourth pixel in the second uncompensated region is smaller than a third threshold, wherein the first threshold is greater than the second threshold, and the first threshold is greater than the third threshold.

16. The electronic device according to claim 13, wherein the display panel compensation method further comprises:
determining a first compensation grayscale value of the first pixel in the first to-be-compensated region according to the first compensation voltage value and a voltage value of a single grayscale; and
determining a second compensation grayscale value of the second pixel in the second to-be-compensated region according to the second compensation voltage value and a voltage value of a single grayscale.

17. A non-transitory computer-readable storage medium, configured to store a computer program, wherein when executing the computer program, a processor implements a display panel compensation method;
wherein the display panel compensation method comprises:
obtaining an initial data voltage value of each pixel in a display panel according to a to-be-displayed image;
determining a to-be-compensated region of the display panel according to the initial data voltage value of each pixel in the display panel, wherein the to-be-compensated region comprises a first to-be-compensated region and a second to-be-compensated region that are adjacent to each other in a first direction, and an absolute value of a difference between an initial data voltage value of a first pixel in the first to-be-compensated region and an initial data voltage value of a second pixel in the second to-be-compensated region is larger than a first threshold; and
determining a first compensation voltage value of the first pixel in the first to-be-compensated region according to a difference between the initial data voltage value of the first pixel in the first to-be-compensated region and a first target voltage value; and
determining a second compensation voltage value of the second pixel in the second to-be-compensated region according to a difference between the initial data voltage value of the second pixel in the second to-be-compensated region and a second target voltage value.

18. The non-transitory computer-readable storage medium according to claim 17, wherein the first to-be-compensated region comprises a plurality of first pixels, and the second to-be-compensated region comprises a plurality of second pixels;
wherein an average value of initial data voltage values of the plurality of first pixels is a first average value;
an average value of initial data voltage values of the plurality of second pixels is a second average value; and
an absolute value of a difference between the first average value and the second average value is larger than the first threshold.

19. The non-transitory computer-readable storage medium according to claim 17, wherein the display panel compensation method further comprises:
determining an uncompensated region of the display panel according to the initial data voltage value of each pixel in the display panel, wherein the uncompensated region comprises a first uncompensated region and a second uncompensated region that are adjacent to each other, the first uncompensated region and the first to-be-compensated region are adjacent to each other in the first direction, the second uncompensated region and the second to-be-compensated region are adjacent to each other in the first direction, an absolute value of a difference between the initial data voltage value of the first pixel in the first to-be-compensated region and an initial data voltage value of a third pixel in the first uncompensated region is smaller than a second threshold, and an absolute value of a difference between the initial data voltage value of the second pixel in the second to-be-compensated region and an initial data voltage value of a fourth pixel in the second uncompensated region is smaller than a third threshold, wherein the first threshold is greater than the second threshold, and the first threshold is greater than the third threshold.

20. The non-transitory computer-readable storage medium according to claim 17, wherein the display panel compensation method further comprises:
determining a first compensation grayscale value of the first pixel in the first to-be-compensated region according to the first compensation voltage value and a voltage value of a single grayscale; and
determining a second compensation grayscale value of the second pixel in the second to-be-compensated region according to the second compensation voltage value and a voltage value of a single grayscale.
